(19) United States
(12) Patent Application Publication
(10) Pub. No.: US 2023/0289382 A1
(43) Pub. Date: Sep. 14, 2023

(54) COMPUTERIZED SYSTEM AND METHOD FOR PROVIDING AN INTERACTIVE AUDIO RENDERING EXPERIENCE

(71) Applicant: Musixmatch, Bologna (IT)

(72) Inventors: Marco Paglia, Bologna (IT); Alessio Albano, Bologna (IT); Giovanni Piemontese, Bologna (IT); Loreto Parisi, Bologna (IT); Federico Terzi, Bologna (IT)

(73) Assignee: Musixmatch, Bologna (IT)

(21) Appl. No.: 17/654,572

(22) Filed: Mar. 11, 2022

(51) Int. Cl. G06F 16/683; G06F 16/68; G06F 40/242; G06F 40/169; G06F 16/638

(52) U.S. Cl. CPC G06F 16/685; G06F 16/686; G06F 40/242; G06F 40/169; G06F 16/638

(57) ABSTRACT

The disclosed systems and methods provide a novel framework that generates electronic, interactive transcripts for media, and dynamic playback capabilities via a user interface (UI) for the accompanying media. The framework generates a transcript file from an audio file, where the transcript functions as a media item itself via included deep-linking interface objects associated with detected topics, context, entities, speakers, sections, and the like. Accordingly, specific text within the transcript is selectable thereby causing search functionalities, and the transcript is segmented according to different identified speakers. The framework provides controls that enable synchronizing audio to specific terms, and portions and/or speaker tags within the transcript, which enables rendering of specific portions of the audio file directly from the transcript across terms and speakers. Thus, the framework provides a novel UI that enables dynamic playback of the accompanying audio and discovery of supplemental content related to a context of the audio.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of network-based computerized content hosting and providing devices, systems and/or platforms by modifying the capabilities and providing non-native functionality to such devices, systems and/or platforms through a novel and improved framework for navigating, modifying and rendering audio content.

### BACKGROUND

Currently, there are a variety of different platforms and applications that enable streaming and rendering of online content. For example, users are capable of downloading or streaming movies, videos and audio (e.g., songs and podcasts, for example) directly via their devices over the Internet.

### SUMMARY

However, conventional mechanisms for rendering such content are still based on functionalities implemented when tapes and other analog formats became available. For example, if a user desires to skip to particular portions of content, navigate to a particular term and/or render content according to a particular pattern, the user must use traditional control keys (e.g., play, rewind, fast forward) to manipulate playback. Even as media converted to digital, the control for rendering content advanced only to navigating per chapter (e.g., skipping to next track, for example). Then, as content moved online, a “progress bar” was provided that enabled manually scrolling through renderable content (e.g., the “red” playback bar on YouTube® videos, for example).

The disclosed systems and methods provide a novel playback framework that addresses the current shortcomings in conventional playback systems, among others, by providing computerized systems and methods that generate interactive transcripts for audio portions of media content, which thereby provides dynamic playback capabilities for the accompanying media content, as discussed herein.

It should be understood that while the focus of the discussion of the disclosed systems and methods herein will be directed to audio files (e.g., podcasts, for example), it should not be construed as limiting, as any type of renderable content can be utilized within the disclosed systems and methods without departing from the scope of the instant disclosure. For example, the content being analyzed can include, but is not limited to, audio, video, images, text, multimedia, and the like, or some combination thereof.

According to some embodiments, as discussed in more detail below, the disclosed framework enables the generation of an interactive, electronic transcript of an audio file (or an audio portion of a multimedia media item, or the speaking/singing portions for a song, for example). The generated transcript functions as a generated media item in itself by having included there deep-linking interface objects (IOs) that are associated with, but not limited to, detected topics, entities, context, categories, speakers, sections, keywords, and the like (which can be used interchangeably). For example, if audio file is a podcast discussing Major League Baseball (MLB®), then when the speakers are discussing certain teams, those teams can be detected as particular entities, and the textual display of their names can be modified to be hyperlinked, where the hyperlinks can connect to related podcasts within a data library and/or the teams' MLB website (or other remotely located network resources).

In another non-limiting example, the transcript can be segmented (or partitioned) according to different speakers. As discussed in more detail below, the disclosed framework can analyze the audio characteristics of the speaker(s), and not only determine their identity, but determine and partition the transcript according to each iteration associated with a speaker within the audio content.

Accordingly, in some embodiments, the disclosed framework can provide novel controls that enable mapping or synchronizing audio to specific terms, portions and/or speaker tags within the transcript. This can enable rendering of specific portions of the audio file directly from the transcript, while also being able to control navigation across terms and speakers, as discussed in more detail below.

As such, as discussed below in more detail, the disclosed systems and methods provide a novel interactive user interface (UI) that correlates with a transcription framework to enable streamlined rendering of content. The supplemental supportive manner in which a generated text transcript synchronously renders audio content in a time-based driven manner enables novel rendering controls for the playback of the audio. Thus, the disclosed framework enables the discovery of a more robust and insightful experience with a podcast, for example, thereby enabling a user to not only listen to the audio content, but experience it further by reading along with the audio and exploring supplemental content that is deep-linked within the text of the transcript, where the supplemental content corresponds to the context and/or topics being discussed within the podcast.

In accordance with one or more embodiments, the present disclosure provides computerized methods for a novel framework for generating electronic, interactive transcription files for audio content, thereby providing a novel UI that enables dynamic playback of the accompanying audio and discovery of supplemental content related to a context of the audio. Indeed, as discussed in more detail below, specific portions of audio can be identified, which can enable directive rendering of those portions via interaction with a displayed, interactive version of the audio's transcript.

In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, content server, ad server and/or client device, and the like) cause at least one processor to perform a method for a novel and improved framework for generating electronic, interactive transcription files for audio content, thereby providing a novel UI that enables dynamic playback of the accompanying audio and discovery of supplemental content related to a context of the audio.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIG. 4 is a block diagram illustrating an exemplary data flow in accordance with some embodiments of the present disclosure;

FIGS. 5A-5B are block diagrams illustrating exemplary data flows in accordance with some embodiments of the present disclosure;

FIG. 6 is a block diagram illustrating an exemplary data flow in accordance with some embodiments of the present disclosure;

FIG. 7 illustrates an example non-limiting embodiment in accordance with some embodiments of the present disclosure;

FIG. 8 is a block diagram illustrating an exemplary data flow in accordance with some embodiments of the present disclosure;

FIG. 9 illustrates an example non-limiting embodiment in accordance with some embodiments of the present disclosure;

FIG. 10 illustrates an example non-limiting embodiment in accordance with some embodiments of the present disclosure;

FIG. 11 illustrates an example non-limiting embodiment in accordance with some embodiments of the present disclosure; and

FIG. 12 illustrates an example non-limiting embodiment in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

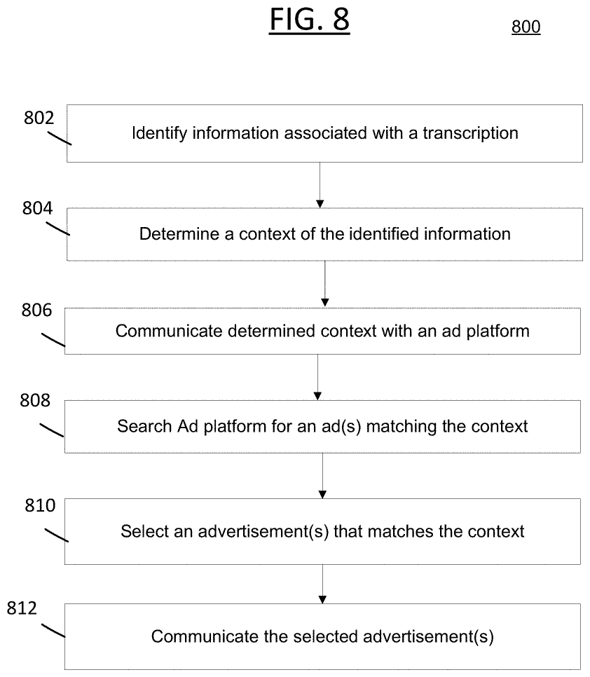

As discussed in more detail below at least in relation to FIG. 8, according to some embodiments, information associated with, derived from, or otherwise identified from, during or as a result of a generation, rendering and/or display of a transcription of an audio file, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

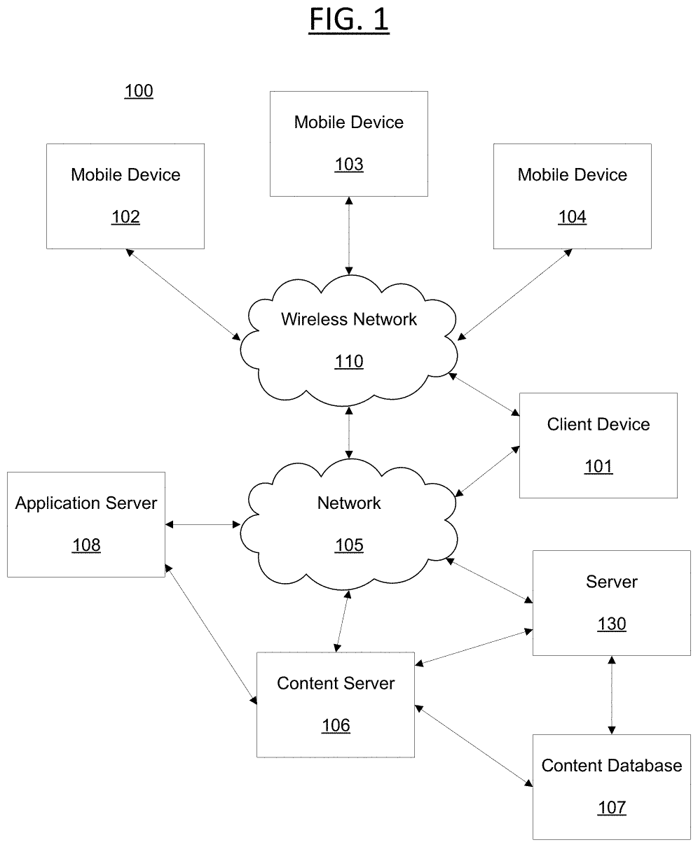

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)-network 105, wireless network 110, mobile devices (client devices) 102-104 and client device 101. FIG. 1 additionally includes a variety of servers, such as content server 106, application (or “App”) server 108 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like.

According to some embodiments, content server 106 can be configured to provide services, applications and/or content related to, but not limited to, streaming and/or downloading media services (e.g., podcasts, for example).

According to some embodiments, content server 106 can further provide a variety of services that include, but are not limited to, email services, instant messaging (IM) services, search services, photo services, web services, social networking services, news services, third-party services, audio services, video services, SMS services, MMS services, FTP services, voice over IP (VOIP) services, or the like.

Third party server 130 can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user data. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is, advertisers will pay higher advertising rates when they believe their ads are being placed in or along with highly relevant content that is being presented to users. Reductions in the time needed to quantify a high quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers. For web portals, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In some embodiments, users are able to access services provided by servers 106, 108 and/or 130. This may include in a non-limiting example, streaming media servers, authentication servers, search servers, email servers, social networking services servers, SMS servers, IM servers, MMS servers, exchange servers, photo-sharing services servers, travel services servers, and the like, via the network 105 using their various devices 101-104.

In some embodiments, applications, such as streaming media applications (e.g., Spotify®, Netflix®, Apple Music®, and the like), mail applications (e.g., Gmail®, and the like), instant messaging applications, blog, photo or social networking applications (e.g., Facebook®, Twitter®, Instagram®, and the like), search applications (e.g., Google® Search), news applications (e.g., Huffington Post®, CNN®, and the like) and the like, can be hosted by the application server 108 or content server 106, and the like.

Thus, the application server 108, for example, can store various types of applications and application related information including application data and user profile information (e.g., identifying and behavioral information associated with a user, as well as data related to hosted media (e.g., audio files, for example)). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108 and/or 130.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

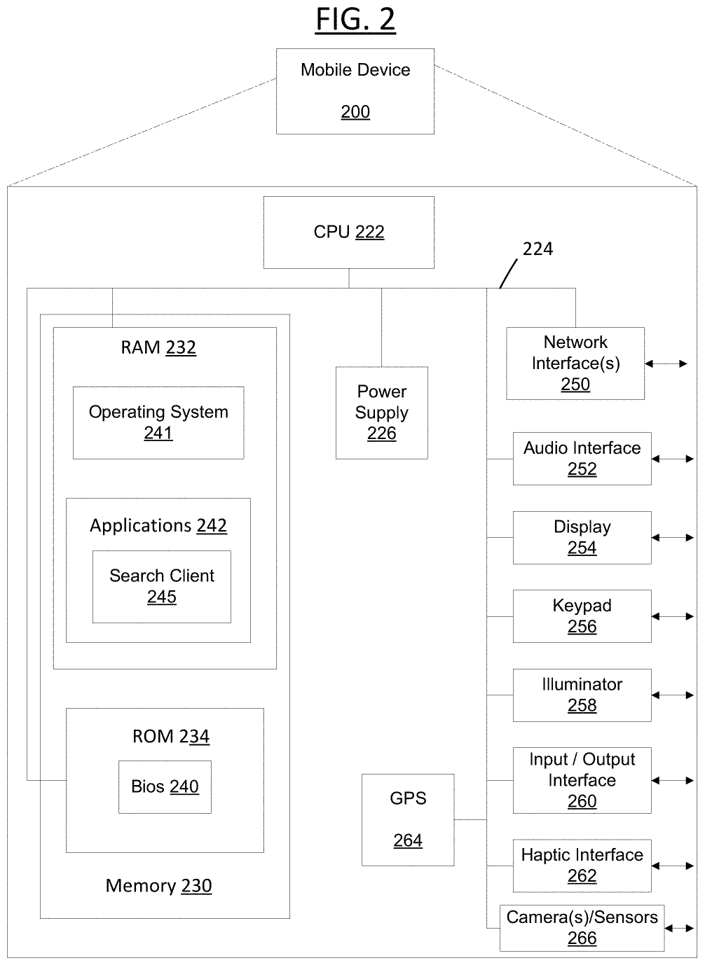

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to Client device 200.

Client device 200 may optionally communicate with a base station (not shown), or directly with another computing device. Network interface 250 is sometimes known as a transceiver, transceiving device, or network interface card (NIC).

Audio interface 252 is arranged to produce and receive audio signals such as the sound of a human voice. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. Illuminator 258 may provide a status indication and/or provide light.

Client device 200 also comprises input/output interface 260 for communicating with external. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. In one embodiment, however, Client device may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200

Memory 230 further includes one or more data stores, which can be utilized by Client device 200 to store, among other things, applications 242 and/or other information or data. For example, data stores may be employed to store information that describes various capabilities of Client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

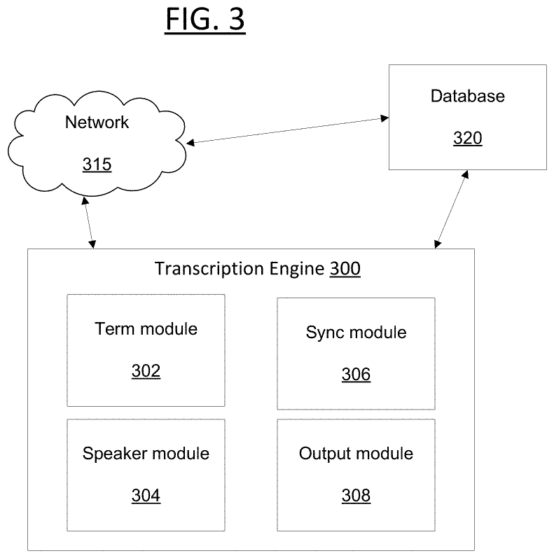

FIG. 3 is a block diagram illustrating the components for performing the systems and methods discussed herein. FIG. 3 includes transcription engine 300, network 315 and database 320. The transcription engine 300 can be a special purpose machine or processor and could be hosted by a cloud server (e.g., cloud web services server(s)), application server, content server, social networking server, web server, search server, content provider, third party server, user's computing device, and the like, or any combination thereof.

According to some embodiments, transcription engine 300 can be embodied as a stand-alone application that executes on a user device. In some embodiments, the transcription engine 300 can function as an application installed on the user's device, and in some embodiments, such application can be a web-based application accessed by the user device over a network. In some embodiments, the transcription engine 300 can be installed as an augmenting script, program or application (e.g., a plug-in or extension) to another application or portal data structure.

The database 320 can be any type of database or memory, and can be associated with a content server on a network (e.g., content server or application server) or a user's device (e.g., device 101-104 or device 200 from FIGS. 1-2). Database 320 comprises a dataset of data and metadata associated with local and/or network information related to users, services, applications, content and the like.

In some embodiments, such information can be stored and indexed in the database 320 independently and/or as a linked or associated dataset. A non-limiting example of this is look-up table (LUT) or even a blockchain. As discussed above, it should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with users, audio, transcripts, images, videos, text, products, items and services from an assortment of media, applications and/or service providers and/or platforms, and the like. Accordingly, any other type of known or to be known attribute or feature associated with a content item, data item, login, logout, website, application, communication (e.g., a message) and/or its transmission over a network, a user and/or content included therein, or some combination thereof, can be saved as part of the data/metadata in datastore 320.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the transcription engine 300, and the database of stored resources 320. Indeed, as illustrated in FIG. 3, the transcription engine 300 and database 320 can be directly connected by any known or to be known method of connecting and/or enabling communication between such devices and resources.

The principal processor, server, or combination of devices that comprise hardware programmed in accordance with the special purpose functions herein is referred to for convenience as transcription engine 300, and includes term module 302, speaker module 304, sync module 306 and output module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

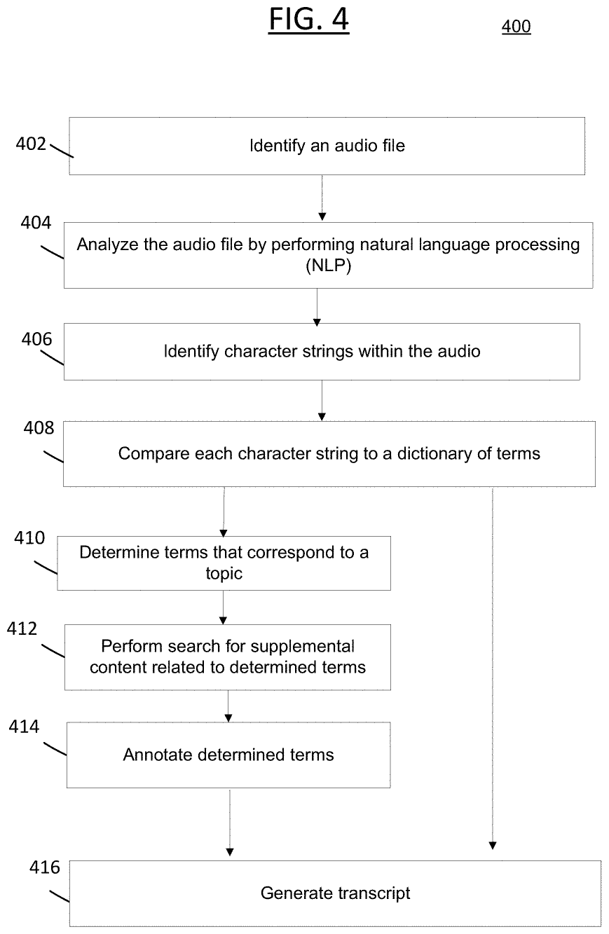

Turning to FIG. 4, Process 400 details non-limiting embodiments for generating a transcript for an audio file, and identifying key terms included therein. By way of a non-limiting example, as discussed in more detail below, Process 400 can enable the generation of a transcript for a podcast, where the proper nouns mentioned are specifically delineated as selectable icons when viewing the text of the transcript.

It should be understood that while the discussion herein will focus on a single audio file (e.g., for Processes 400-600), it should not be construed as limiting, as the processing described herein can be performed a plurality of audio files (as well as other forms of content that have audio portions, as mentioned above) without departing from the scope of the instant disclosure.

According to some embodiments, Steps 402-414 of Process 400 can be performed by term module 302 of transcription module 300; and Step 416 can be performed by output module 308.

Process 400 begins with Step 402 where an audio file is identified. In some embodiments, as discussed below, the audio file can be identified as part of a search. In some embodiments, the audio file can be a file that is part of a collection (or library) of audio files, can be a file that is being streamed, uploaded, downloaded, shared, and the like, or some combination thereof. In some embodiments, the audio file, and its transcript generation discussed herein, can be an audio file that is currently being created, such that the transcript is being created as the creators of the file record the audio.

In Step 404, engine 300 can analyze the audio file. According to some embodiments, the analysis of Step 404 can involve parsing the audio file and identifying the portions that correspond to the audio content (e.g., spoken language), while filtering out background noise or feedback.

According to some embodiments, Step 404 can involve performing computational analysis on the audio file (and/or identified audio content). In some embodiments, this can involve engine 300 performing natural language processing (NLP) techniques on the audio file, such as, but not limited to, neural NLP, syntactic NLP processing, lexical semantics, relational semantics, disclosure semantics, natural language understanding (NLU), and/or any other type of known or to be known high-level NLP processing.

According to some embodiments, engine 300 can perform the computational analysis performed in Step 404 according to any type of known or to be known artificial intelligence (AI) or machine learning (ML) algorithm, technique, mechanism or technology, such as, but not limited to, computer vision, Bayesian network analysis, Hidden Markov Models, neural network analysis (e.g., artificial neural networks (ANNs), convolutional neural networks (CNNs), and the like), logical model and/or tree analysis, and the like.

In Step 406, as a result of the NLP analysis processing in Step 404, character strings from the audio of the audio file are identified. According to some embodiments, the character strings can correspond to, but are not limited to, words, terms, names, phrases, sentences, paragraphs, and the like, or some combination thereof.

Having identified the terms being spoken (or audibly rendered) in the audio file, Process 400 proceeds to Step 408 where a determination of which terms (or character strings) mentioned correspond to a topic.

For purposes of this disclosure, a topic can correspond to a proper noun (e.g., an entity, business, person, and the like), a category, a context, an item, keyword, and/or any other type of specifically identifiable physical or digital item, person, company, or artifact. In other words, which terms correlate to entities or topics that warrant additional attention in a transcript.

For example, if the audio of the audio file is discussing COVID-19, then each time the speaker mentions COVID-19, or mentions locations to get tested or get a vaccine (e.g., a specific hospital and/or pharmacy), then this can trigger the subsequent steps of Process 400.

Thus, in Step 408, the terms identified from the audio (from Step 406) are compared against a set of dictionaries (e.g., which can correspond to known words or phrases for a specific language, slang terms, geographical terms, business entities, and the like). In some embodiments, the comparison can be performed according to the ML/AI processing discussed above in relation to Step 404.

In Step 410, based on the comparison performed in Step 408, engine 300 can determine (or otherwise identify) terms from the audio that correspond to a topic. For example, as mentioned above, the name of the coronavirus in the audio file: COVID-19, and the names of the pharmacies issuing vaccines: CVS®, for example.

In Step 412, engine 300 can perform a search for supplemental content related to the determined terms. Such search can be performed from a local library of content or over the Internet, or both. For example, engine 300 can search for other audio files (e.g., podcasts) that mention, are tagged with or are otherwise associated with the topic (or determined term(s)). In another example, Wikipedia® can be searched for information related to topic (or determined term(s)).

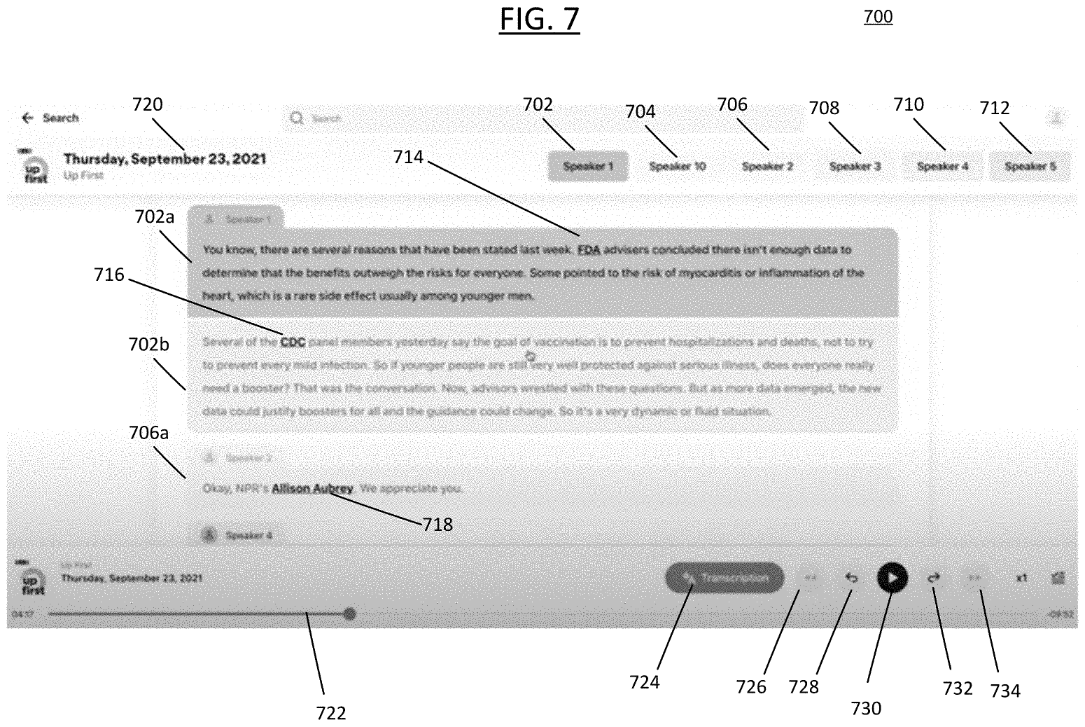

In Step 414, upon identifying the supplemental content in Step 412, engine 300 can annotate each term with the discovered supplemental content. In some embodiments, such annotation can involve appending information to the terms that enables deep-linking features when the terms are displayed. For example, the terms can be annotated (e.g., modified) so that they appear as hyperlinks connected to the network locations from where the supplemental content was identified. In some embodiments, interaction with the hyperlinked term can cause a pop-up window, overlay, VR/AR display, and/or any other form of supplemental display screen to be rendered. In some embodiments, a new window can be displayed (e.g., as a tab within a browser or application UI) that displays the supplemental content). Discussion of such embodiments, inter alia, are provided below in relation to FIG. 7.

In Step 416, engine 300 generates the transcript (e.g., creates an electronic transcript file). The transcript is based on the annotated terms from Step 414 and the terms that did not require annotation (as determined from Steps 406-408). Thus, as illustrated in FIG. 7 below, and discussed in more detail below, a transcript can be generated and displayed that enables (or causes) rendering of audible content of the audio file in conjunction with displayed and/or selected text. Such transcript can be saved as an electronic file in an associated database (e.g., database 320 of FIG. 3)

In line with the below discussion, according to some embodiments, an audio file that has a generated transcript can be ranked higher (e.g., weighted) than other audio files related to a similar topic within a library of audio files, thereby enabling their identification in a search prior to those audio files that are not transcribed according to the systems and methods discussed herein.

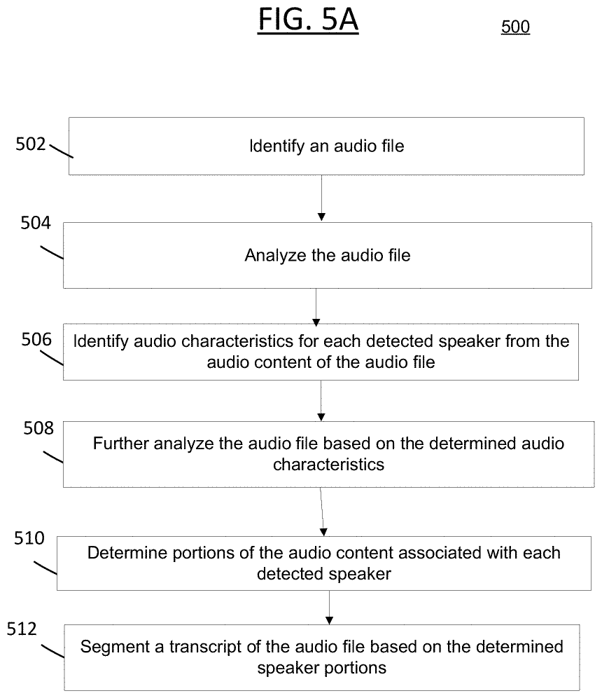

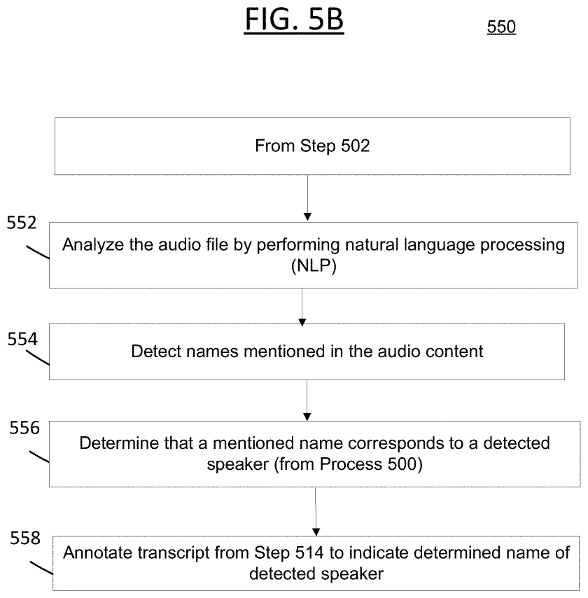

In FIGS. 5A-5B, Processes 500 and 550, respectively, provide non-limiting example embodiments for identifying which speakers are audibly speaking within the audio content of the audio file, and outputting a transcript of the audio file so as to enable a speaker-based rendering as well as identification of which portions the speakers are associated with.

Turning to FIG. 5A, Process 500 discloses embodiments for segmenting a transcript according to the portions associated with each speaker. That is, a generated transcript can be partitioned so that it is visibly discernable which speakers are associated with text, and the partitions are interactive so as to enable rendering via and/or from specific portions of the speaker's audio content.

According to some embodiments, Steps 502-510 can be performed by speaker module 304 of transcription engine 300; and Step 512 can be performed by output module 308.

Process 500 begins with Step 502 where an audio file is identified. Step 502 can be performed in a similar manner as discussed above in relation to Step 402.

In Step 504, the audio file is analyzed. The analysis performed in Step 504 by engine 300 is focused on determining speaker attributes, characteristic and/or features that can be used to differentiate one speaker form another. According to some embodiments, the analysis performed herein can be performed according to ML/AI processing discussed above in relation to Step 404—in other words, detect words, terms and pauses in speech, and the like, and analyze characteristics of the audio for each speaker.

In Step 506, engine 300 can identify audio characteristics of the audio content, with a specific focus on characteristics of each detected speaker. According to some embodiments, based on the analysis of Step 504, engine 300 can detect, for each speaker, information related to, but not limited to, melody, tone, tempo, volume, beats per minute (BPM), fade ins/outs, transitions, source separation, accompaniment, bass, treble, amplitudes, structure, rhythm, harmonics, background noise, energy, pitch, silence rates, bit rates, speech and/or any other acoustic or digital signal processing (DSP) metric, value or characteristic that is identifiable from an audio file, or some combination thereof, that can be determined, derived, extracted or otherwise identified.

In some embodiments, for example, voice portions, portions attributed to certain speakers, and/or other information related to types of audio characteristics (e.g., tone, volume, rhythm, and the like), can be extracted from the portions as a by-product or result of the computerized analysis of Step 506.

In Step 508, engine 300, based on the detected audio characteristics for each speaker, re-analyzes (or further analyzes) the audio file. This can involve, but is not limited to, transforming the audio file to a n-dimensional feature vector, then generating a query for each speaker that includes a vector corresponding to speaker's characteristics, then performing comparative vector analysis with the vector of the audio file.

As a result, in Step 510, portions of the audio content that are associated with each detected speaker can be determined. As discussed herein, this can involve identifying sequential portions related to a speaker, and/or randomly situated portions (e.g., non-linear portions). For example, Speaker 1 speaks, then Speaker 2, then Speaker 1, then Speaker 3, and so on.

In Step 512, engine 300 can partition the transcript into segments that correspond to each speaker. For example, the transcript generated in Process 400 can be further processed so that the speakers related to each portion are identified (which can include different tags, labels, colors, graphics, sound effects, haptic effects, size, shape, and the like, or some combination thereof).

According to some embodiments, Step 512 can involve transforming each speaker's portion into an interactive IO so that it is not only selectable, it is also modifiable (by an editor or administrator, for example, change the order of speakers, and/or edit the text included therein) and renderable (e.g., can select and play from a specific portion). Embodiments of these capabilities are discussed in more detail below in relation to FIG. 7.

In some embodiments, the created (or modified) transcript can be saved as an electronic file, inclusive of the IOs, in an associated database (e.g., database 320 of FIG. 3).

Turning to FIG. 5B, Process 550 discloses embodiments for determining a name of a detected speaker, and providing an indication of that name (e.g., an identifier) within the segmented transcript.

According to some embodiments, Steps 552-554 can be performed by term module 302 of transcription engine 300; Step 556 can be performed by speaker module 304; and Step 558 can be performed by output module 308.

Process 550 begins with Step 552, which proceeds from Step 502 (e.g., the identification of the audio file). In Step 552, engine 300 analyzes the audio file via the ML/AI processing discussed above (at least in relation to Step 404 and 504). In Step 554, as a result of the ML/AI analysis, engine 300 can detect names being spoken within the audio file (in a similar manner as discussed above).

In Step 556, engine 300 can further perform ML/AI processing (as discussed supra), and determine whether particular names being spoken correspond to one of the speakers of the audio file. In some embodiments, Step 556 can involve engine 300 determining that a speaker mentioned their name and/or another speaker's name. For example, Speaker 1 can say, “Welcome to the podcast, my name is Bob”. Thus, based on the detection of the introductory text “my name is”, the following character string (or term) detected can be identified as Speaker 1's name: “Bob.”

In Step 558, engine 300 can annotate the segmented transcript (from Process 500, supra) based on the determined names of detected speakers. The annotation can be performed in a similar manner as discussed above in relation to Step 414, where a notation of a speaker can be modified to be replaced by that speaker's name (e.g., and can be annotated with supplemental content, as discussed above).

In some embodiments, the created (or modified) transcript can be saved as an electronic file in an associated database (e.g., database 320 of FIG. 3).

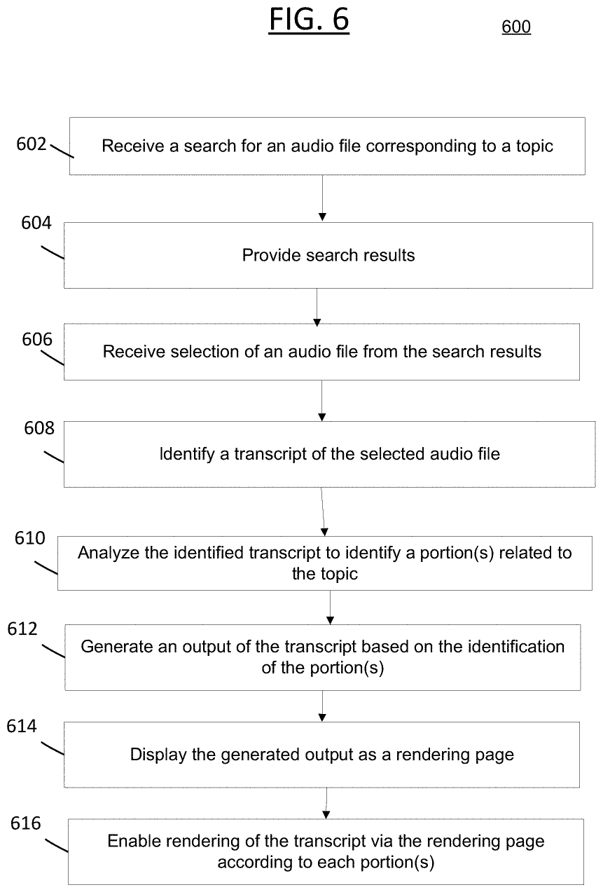

Turning to FIG. 6, Process 600 discloses embodiments where a search for audio files related to a specific topic (e.g., a context or entity, for example) is performed, and a transcript for a selected audio file is displayed and rendered that enables a robust experience with the text of the transcript and audio content related to each transcript portion.

According to some embodiments, Steps 602-610 and 616 can be performed by sync module 306 of transcription engine 300; and Steps 612-614 can be performed by output module 308.

Process 600 begins with Step 602 where a search for an audio file is received. In some embodiments, the search can be an input entry (e.g., a text, voice, image, and/or any other type of input capable of triggering a search) and/or a selection from a provided set of topics, and the like. For example, a user can enter a query that indicates a topic (e.g., entry a text search query). In other example, a user can visit a page where popular (or trending) topics are listed, and upon selection of an IO associated with a topic, a search is received by engine 300.

As discussed above, the topic can correspond to a context and/or entity. For example, the search can be for identifying an audio file(s) related to, but not limited to, a speaker, a topic of the audio (e.g., what they are discussing), terms discussed therein, a time, date, source of the audio, popularity of the file, how recent the file is, and the like, or some combination thereof.

In Step 604, a set of audio files can be returned and displayed in response to the search. For example, if the search was related to identifying podcasts where President Obama is a speaker, then the results will includes such podcasts.

In Step 606, engine 300 receives a selection of an audio file from the provided search results. In some embodiments, a user can provide the selection. In some embodiments, engine 300 can automatically select a top-ranked result, which can be based on preferences of the user, an administrator, a service agreement, streaming agreement, metrics of the files (e.g., how popular the file is, for example), and the like, or some combination thereof.

In Step 608, the transcript related to the selected audio file is identified from a library of transcripts. In some embodiments, if the selected audio file does not have a generated audio file, then Step 608 can involve calling Processes 400, 500 and/or 550 to generate the transcript. In some embodiments, Step 608 can involve calling such processes even when a transcript has been generated so as to enable an up-to-date or current transcript to be provided. In some embodiments, a determination can be made regarding when the transcript was created, and if that date fails a threshold date (e.g., created 3 months prior to the selection of Step 606), then Processes 400, 500 and/or 550 can be re-performed accordingly.

In Step 610, the identified transcript can be analyzed based on the topic within the search. This enables the identification of the most relevant portions in connection with the originating search (from Step 602). For example, continuing with the above Pres. Obama example, Step 610 can involve engine 300 determining which portions of a selected podcast correspond to when he is speaking (e.g., identify those IOs within the stored transcript file). According to some embodiments, the analysis and determination of Step 610 can be performed via the ML/AI processing discussed supra.

In Step 612, engine 300 can generate an output of the transcript based on the identification of the portions. In some embodiments, the output can correspond to a UI view where the transcript is scrolled to a first portion of the identified relevant portions from Step 610. In some embodiments, the output can correspond to a UI view where only (or at least a portion of) the related portions are displayed (e.g., display, at least initially with toggling capabilities, the speaking portions of Pres. Obama only, for example).

In Step 614, the generated output is caused to be displayed, and is displayed in a manner in conjunction with the configuration of the output from Step 612. In some embodiments, the display can be effectuated on a display or rendering page of a browser, and in some embodiments, the display can correspond to a display screen or rendering page of a proprietary application (e.g., an application for streaming podcasts via a user's mobile device, for example).

And, in Step 616, engine 300 enables rendering of the audio file via the displayed page upon which the output was displayed. As discussed above, and discussed below in relation to FIG. 7, the audio file can be played from each IO portion, can be skipped according to speaker portions and can enable discovery of additional content related to the topics and/or text of the audio's transcript.

Turning to FIG. 7, UI 700 provides a non-limiting example embodiment of a displayed transcript for a renderable audio file according to the systems and methods discussed herein. It should be understood that the embodiments of UI 700 discussed herein are exemplary for purposes of illustrating non-limiting example embodiments of Processes 400-600, supra.

According to some embodiments, UI 700 displays a rendering page for an audio file; for example, a podcast 720 (e.g., UpFirst™, which aired on Sep. 23, 2021). From the above processing, engine 300 detects that the podcast 720 has 10 speakers, as indicated by items 702-712 (where the listing of speakers, in some embodiments, is scrollable and/or is updated based on how recent or proximate to a current or rendering time a particular speaker's audio was output). Each speakers portion can be displayed as an IO, which is an interactive displayed item within the UI 700 that displays text of a specific speaker and can cause direct rendering from that position of the audio file.

For example, Speaker 1, item 702, has two (2) segmented portions of text: items 702a and 702b. As discussed above, if a viewing user selects or interacts with (e.g., touch input) items 702a or 702b, the audio will begin playing directly from the audio portion related to that transcription portion. In some embodiments, selection of an IO can cause its display to change color (or shape, size, or output a haptic effect, and the like, or some other form of output) in order to provide an indication that a selection was made.

As illustrated in FIG. 7, underlined text 714 within IO 702a, and text 716 within IO 702b, respectively, display capabilities for rendering supplemental content, as discussed above (e.g., they present as hyperlinks that enable the display and/or searching for additional content, accordingly).

In another example, Speaker 2, item 706, has displayed segmented portion 706a, which includes detected entity “Allison Aubrey”, which is hyperlinked (e.g., item 718) for further discovery.

It should be clear by those of skill in the art that the transcript page is scrollable, and since UI 700 is only displaying Speaker 1 and Speaker 2, it should not be construed as limiting, as it should be understood that upon scrolling the page of UI 700, portions/IOs of the other eight speakers can become viewable.

UI 700 further displays scroll bar 722, which includes functionality for tracking progress of the audio file, as well as scrubbing the audio filed.

UI 700 further includes transcription button 724. Button 724 enables a selection to be “locked” so that upon a user scrolling to a different portion of UI 700, a different page, or different podcast, selecting the button 724 will toggle the viewing screen back to the item that was selected when button 724 was engaged. For example, if a user selects button 724 after selecting item 702a, then traverses to another podcast entirely, selecting button 724 again will cause UI 700 to be displayed as it was when button 724 was engaged (e.g., display item 702a as the rendering portion, and automatically playing (or continuing to play) its accompanying audio portion).

UI 700 further includes buttons, 726-734, which enable rendering and navigation of each portion of the audio as mapped to the transcript. Item 730 enables playing and pausing (or stopping) of the audio.

Items 726 and 734 correspond to rewind and fast-forward capabilities, respectively. Item 728 corresponds to iterative traversal to a previous portion (e.g., either a previous speaker section, a sequential previous section, or the previous section of a particular speaker, and the like). Item 732, similar to item 728, corresponds to an iterative traversal of portions, but rather than previous portions, it corresponds to a next portion(s) (e.g., either a next speaker section, a sequential next section, or the next section of a particular speaker, and the like). Engine 200 can configure items 728 and 732 based on settings provided by a user, podcast provider, administrator, behaviors of the user, and the like, or some combination thereof.

FIG. 8 is a work flow process 800 for serving or providing related digital media content based on the information associated with an audio file and its corresponding transcription, as discussed above in relation to FIGS. 4-7. In some embodiments, the provided content can be associated with or comprising advertisements (e.g., digital advertisement content). Such information can be referred to as “transcript information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 802, transcript information is identified. This information can be derived, determined, based on or otherwise identified from the steps of Processes 400-600, as discussed above in relation to FIGS. 4-6.

For purposes of this disclosure, Process 800 will refer to single transcript (and/or corresponding audio file information); however, it should not be construed as limiting, as any number of transcriptions, for any number of audio files, for any number of users, can form such basis, without departing from the scope of the present disclosure.

In Step 804, a context is determined based on the identified transcript information. This context forms a basis for serving content related to the transcript information. For example, the context can be determined based on a topic or topic(s) of a transcript. For example, if a podcast relates to cooking, then the context determined in Step 804 can be identified as “cooking.”

In some embodiments, the identification of the context from Step 804 can occur before, during and/or after the analysis detailed above with respect to Processes 400-600, or it can be a separate process altogether, or some combination thereof.

In Step 806, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 808, the server searches the database for a digital content item(s) that matches the identified context. In Step 810, a content item is selected (or retrieved) based on the results of Step 808.

In some embodiments, the selected content item can be modified to conform to attributes or capabilities of a device, browser user interface (UI), page, interface, platform, application or method upon which a user session will be initiated, continued and/or retained, and/or to the application and/or device for which a transcript is being displayed and/or rendered (e.g., UI 700, for example).

In some embodiments, the selected content item is shared or communicated via the application or browser the user is utilizing to consume the audio file and/or transcript. Step 812.

In some embodiments, the selected content item is sent directly to a user computing device for display on a device and/or within the UI displayed on the device's display (e.g., within the browser window and/or within an inbox of the high-security property). In some embodiments, the selected content item is displayed within a portion of the interface or within an overlaying or pop-up interface associated with a rendering interface displayed on the device.

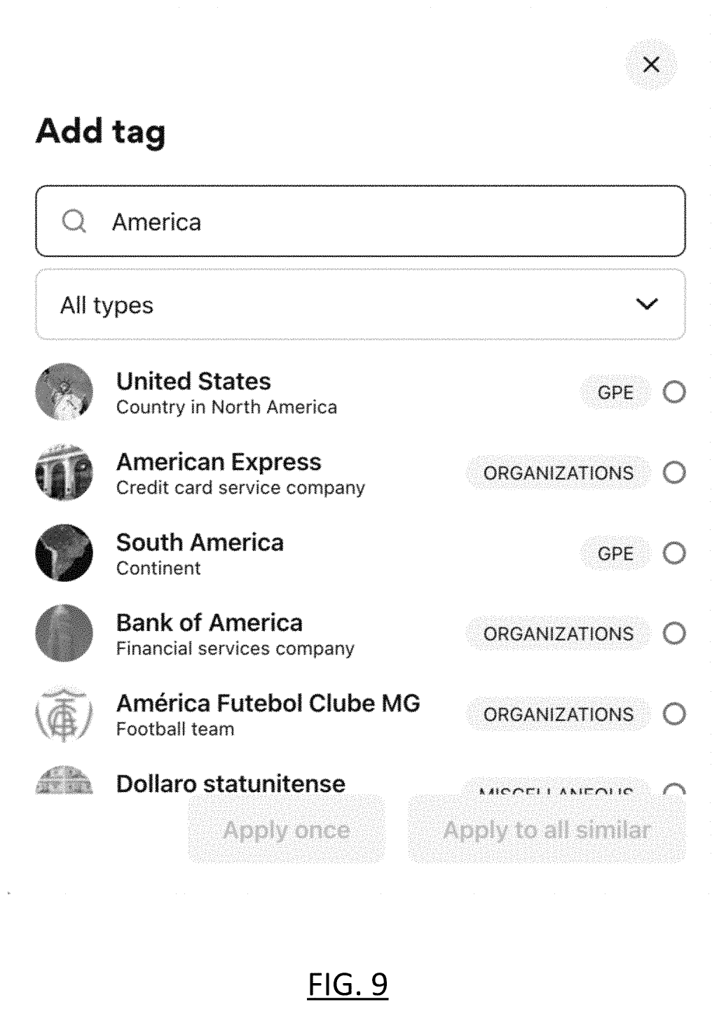

Turning now to FIGS. 9-12, non-limiting example embodiments are disclosed where supplemental content related to entities mentioned in audio (and/or a transcript) can be identified, supplied, searched for, and/or annotated or otherwise associated with a generated transcript. For example, as discussed above, a transcript can be annotated so that information related to an entity can be hyperlinked within the displayed transcript. Indeed, embodiments exist where entity (or topic) identification, annotation and display, as well as searching is language agnostic.

According to some embodiments, the engine 200 can operate in an editor mode. This mode can be operated by a user, or can be automatically executed via the ML/AI operations discussed above. For purposes of this discussion, the editor mode can function as user operated; however, it should not be construed as limiting at least based on the above discussion of how the engine 200 operates.

Turning to FIG. 9, an entity finder UI screen can be provided. This functionality can be triggered by a user selecting a word or words within a transcript, and providing an indication that the word corresponds to an entity that the user desires to annotate with additional information. For example, as illustrated in FIG. 9, a term “America” can be selected and populated into a search box. Auto-populate options can be provided, as illustrated below the search box in FIG. 9. For example, trending, learned or otherwise identified search queries that related to and/or include “America” can be suggested for the user.

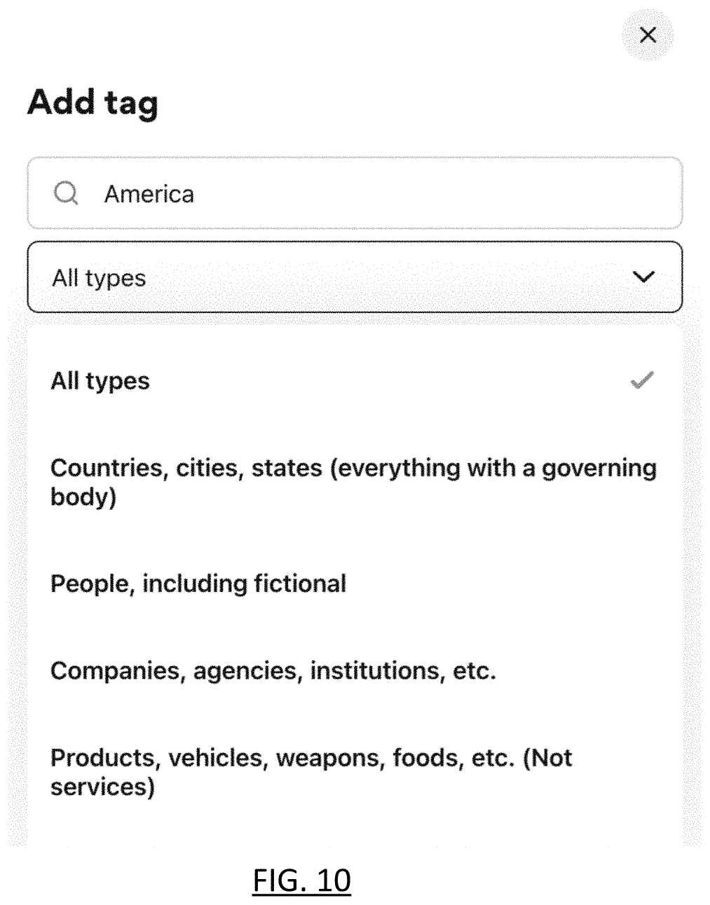

In FIG. 10, functionality for searching for different types of entities that correspond to an entity term (for example, “America”). Using “America” as an entity terms, the types can include, but are not limited to, countries, people, companies, products, bands, names, aliases, and the like (as illustrated in FIG. 10).

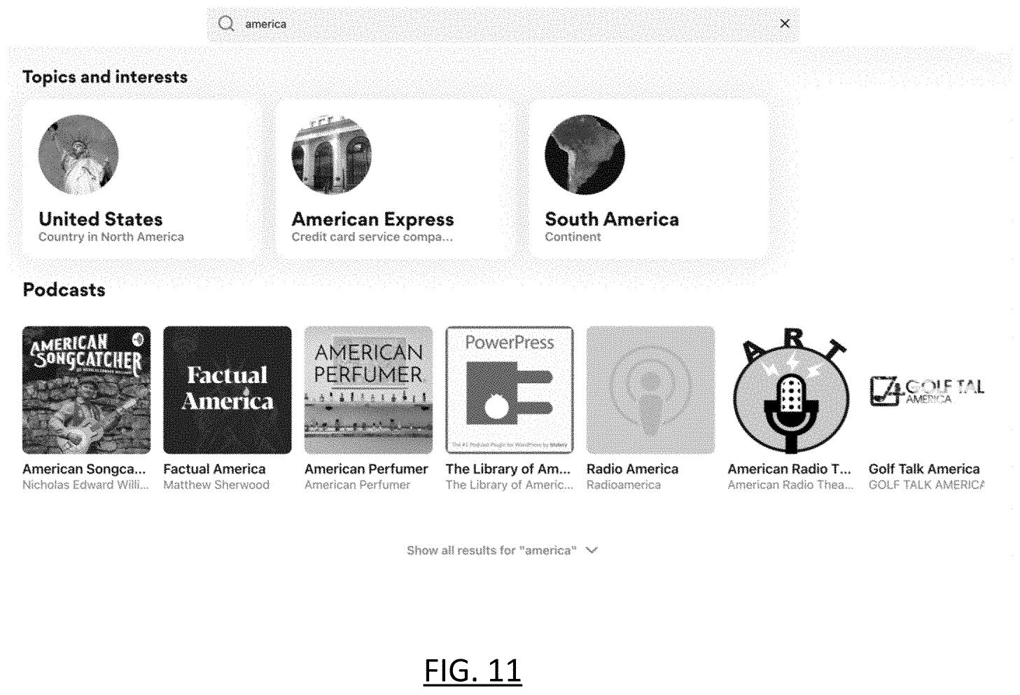

In FIG. 11, a UI screen is displayed, which enables a search. The search can be for information related to an entity that enables annotation, as discussed above at least in relation to FIG. 4. The search can also be in relation to topics, interest and/or other discoverable content, as discussed above at least in relation to FIG. 6. Thus, FIG. 11 provides a graphical user interface that enables searching for and identification of information related to a searched term, which can be topical and/or content-based, among other types of factors for formulating and/or filtering a search.

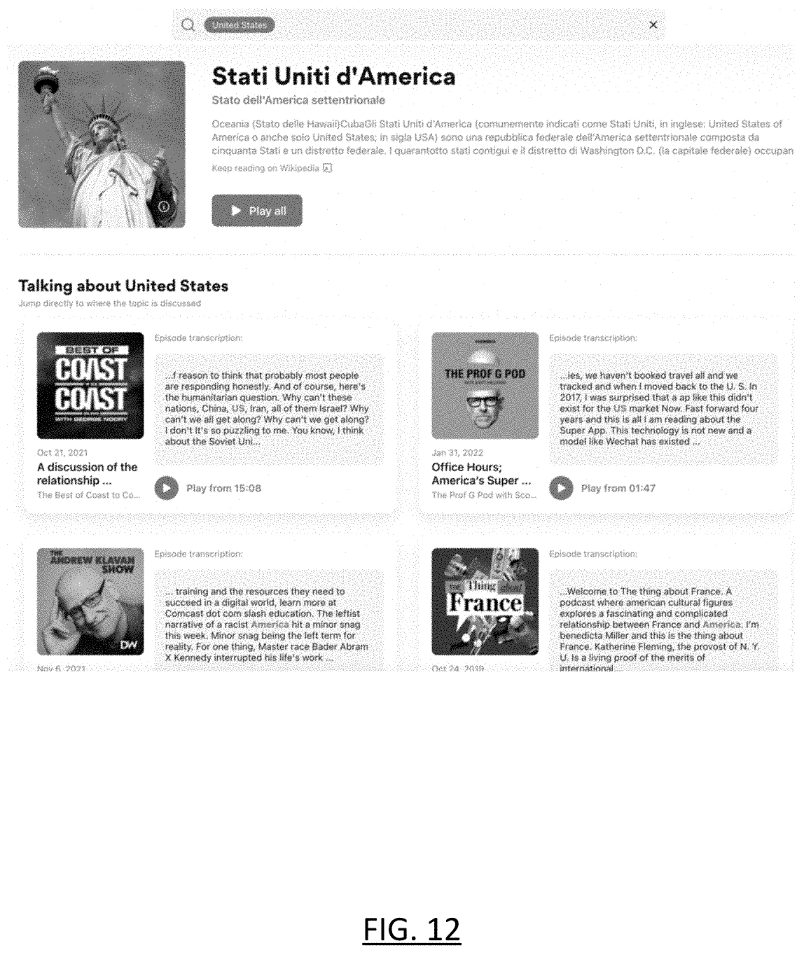

In FIG. 12, a UI screen is displayed that provides an example search results. This connects to what was discussed above in relation to FIGS. 6 and 9-11, where a search term can trigger the discovery of other content that is related to and/or discusses an entity.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a search request comprising information related to a topic;
providing, by the device, a set of search results, each search result corresponding to an audio file comprising audio content related to the topic;
selecting, by the device, an audio file from the set of search results;
identifying, by the device, a transcript file that corresponds to the audio file, the transcript file comprising functionality that enables rendering of the audio file when the transcript is displayed;
analyzing, by the device, the identified transcript, and identifying a portion that corresponds to the topic;
generating, by the device, an output of the identified transcript based on the identification of the portion, the output comprising a configuration of the transcript that enables at least an initial view of the identified portion and rendering of an audio portion related to the identified portion; and
causing, by the device, display of the generated output on a display screen of a user device.

2. The method of claim 1, further comprising:
analyzing the audio file by performing natural language processing (NLP), and identifying a set of terms mentioned via the audio content;
comparing the set of terms to a dictionary of terms;
determining a two subset of terms, a first subset corresponding to terms that correspond to the topic, a second subset corresponding to a remainder of terms;
performing a search for supplemental content for each term in the first subset; and
annotating each term in the first subset based on identified supplemental content.

3. The method of claim 2, wherein the identified transcript comprises the first annotated subset of terms and the second subset of terms.

4. The method of claim 2, wherein the annotation enables a display of the identified supplemental content.

5. The method of claim 2, wherein the search for supplemental content is respective at least one of a local library of audio content and remote network locations.

6. The method of claim 1, further comprising:
analyzing the audio file;
identifying a set of speakers from the audio file, wherein identification of the set of speakers is based on detected audio characteristics for each speaker;
identifying a set of terms within the audio content related to each speaker in the set of speakers;
determining portions of the audio that correspond to a set of terms for each speaker; and
segmenting the transcript based on the determined portions, wherein the identified transcript is a segmented version of the transcript.

7. The method of claim 6, further comprising:
further analyzing the audio file;
detecting names mentioned within the audio content;
determining that at least one detected name corresponds to an identified speaker; and
annotating the transcript to indicate the at least one detected name when displayed, wherein the identified transcript is an annotated version of the transcript.

8. The method of claim 1, further comprising:
determining that the identified transcript is not current based on a threshold; and
generating another transcript for audio file, wherein the identified transcript is the other transcript.

9. The method of claim 1, further comprising:
causing, by the device, communication over the network to a third party platform, the communication comprising information related to the topic of the transcript;
receiving, by the device, a digital content item provided by the third party platform, the digital content item comprising content corresponding to the topic; and
causing, by the device, display of the digital content item in association with the transcript.

10. A non-transitory computer-readable storage medium tangibly encoded with computer-executable instructions, that when executed by a processor associated with a device, performs a method comprising:
receiving, by the device, a search request comprising information related to a topic;
providing, by the device, a set of search results, each search result corresponding to an audio file comprising audio content related to the topic;
selecting, by the device, an audio file from the set of search results;
identifying, by the device, a transcript file that corresponds to the audio file, the transcript file comprising functionality that enables rendering of the audio file when the transcript is displayed;
analyzing, by the device, the identified transcript, and identifying a portion that corresponds to the topic;
generating, by the device, an output of the identified transcript based on the identification of the portion, the output comprising a configuration of the transcript that enables at least an initial view of the identified portion and rendering of an audio portion related to the identified portion; and
causing, by the device, display of the generated output on a display screen of a user device.

11. The non-transitory computer-readable storage medium of claim 10, further comprising:
analyzing the audio file by performing natural language processing (NLP), and identifying a set of terms mentioned via the audio content;
comparing the set of terms to a dictionary of terms;
determining a two subset of terms, a first subset corresponding to terms that correspond to the topic, a second subset corresponding to a remainder of terms;
performing a search for supplemental content for each term in the first subset; and
annotating each term in the first subset based on identified supplemental content.

12. The non-transitory computer-readable storage medium of claim 11, wherein the identified transcript comprises the first annotated subset of terms and the second subset of terms.

13. The non-transitory computer-readable storage medium of claim 11, wherein the annotation enables a display of the identified supplemental content.

14. The non-transitory computer-readable storage medium of claim 10, further comprising:
analyzing the audio file;
identifying a set of speakers from the audio file, wherein identification of the set of speakers is based on detected audio characteristics for each speaker;
identifying a set of terms within the audio content related to each speaker in the set of speakers;
determining portions of the audio that correspond to a set of terms for each speaker; and
segmenting the transcript based on the determined portions, wherein the identified transcript is a segmented version of the transcript.

15. The non-transitory computer-readable storage medium of claim 14, further comprising:
further analyzing the audio file;
detecting names mentioned within the audio content;
determining that at least one detected name corresponds to an identified speaker; and
annotating the transcript to indicate the at least one detected name when displayed, wherein the identified transcript is an annotated version of the transcript.

16. The non-transitory computer-readable storage medium of claim 10, further comprising:
determining that the identified transcript is not current based on a threshold; and
generating another transcript for audio file, wherein the identified transcript is the other transcript.

17. A device comprising:
a processor configured to:
receive a search request comprising information related to a topic;
provide a set of search results, each search result corresponding to an audio file comprising audio content related to the topic;
select an audio file from the set of search results;
identify a transcript file that corresponds to the audio file, the transcript file comprising functionality that enables rendering of the audio file when the transcript is displayed;
analyze the identified transcript, and identify a portion that corresponds to the topic;
generate an output of the identified transcript based on the identification of the portion, the output comprising a configuration of the transcript that enables at least an initial view of the identified portion and rendering of an audio portion related to the identified portion; and
cause display of the generated output on a display screen of a user device.

18. The device of claim 17, wherein the processor is further configured to:
analyze the audio file by performing natural language processing (NLP), and identifying a set of terms mentioned via the audio content;
compare the set of terms to a dictionary of terms;
determine a two subset of terms, a first subset corresponding to terms that correspond to the topic, a second subset corresponding to a remainder of terms;
perform a search for supplemental content for each term in the first subset; and
annotate each term in the first subset based on identified supplemental content,
wherein the identified transcript comprises the first annotated subset of terms and the second subset of terms, and
wherein the annotation enables a display of the identified supplemental content.

19. The device of claim 17, wherein the processor is further configured to:
analyze the audio file;
identify a set of speakers from the audio file, wherein identification of the set of speakers is based on detected audio characteristics for each speaker;
identify a set of terms within the audio content related to each speaker in the set of speakers;
determine portions of the audio that correspond to a set of terms for each speaker; and
segment the transcript based on the determined portions, wherein the identified transcript is a segmented version of the transcript.

20. The device of claim 19, wherein the processor is further configured to:
further analyze the audio file;
detect names mentioned within the audio content;
determine that at least one detected name corresponds to an identified speaker; and
annotate the transcript to indicate the at least one detected name when displayed, wherein the identified transcript is an annotated version of the transcript.
